(19) United States
(12) Patent Application Publication
(10) Pub. No.: US 2014/0153928 A1
(43) Pub. Date: Jun. 5, 2014

(54) COMMUNICATION APPARATUS IN WIDEBAND WIRELESS OPTICAL COMMUNICATION SYSTEM BASED ON FREE SPACE, AND TRANSMISSION AND RECEPTION METHOD USING THE SAME

(71) Applicant: Electronics and Telecommunications Research Institute, Daejeon (KR)

(72) Inventors: Jea Hoon YU, Daejeon (KR); Seung-Hyun CHO, Daejeon (KR); Tae Il KIM, Daejeon (KR); Jeong-Dong RYOO, Daejeon (KR); Tae Whan YOO, Daejeon (KR); Bheom Soon JOO, Daejeon (KR); Jong Hyun LEE, Daejeon (KR); Bong Tae KIM, Daejeon (KR)

(73) Assignee: Electronics and Telecommunications Research Institute, Daejeon (KR)

(21) Appl. No.: 14/096,650

(22) Filed: Dec. 4, 2013

(30) Foreign Application Priority Data
Dec. 5, 2012 (KR) 10-2012-0140441

(51) Int. Cl. H04B 10/11

(52) U.S. Cl. CPC H04B 10/11
USPC 398/115

(57) ABSTRACT

In a wireless optical communication system in which communication is performed based on a free space and a plurality of the communication apparatuses are arranged in a ring form around a central office terminal (COT), the communication apparatus monitors optical signals received in a first direction or in a second direction opposite to the first direction, and selects a first path through which the optical signals in the first direction are received and a second path through which the optical signals in the second direction are received. The communication apparatus converts an optical signal having a predetermined unique wavelength from among the optical signals received through the selected path into a signal of a frequency domain having a plurality of subcarriers, and obtains packet data mapped to each of the subcarriers.

### CROSS-REFERENCE TO RELATED APPLICATION

This application claims priority to and the benefit of Korean Patent Application No. 10-2012-0140441 filed in the Korean Intellectual Property Office on Dec. 5, 2012, the entire contents of which are incorporated herein by reference.

### BACKGROUND OF THE INVENTION

(a) Field of the Invention

The present invention relates to a wireless optical communication system, and more particularly, to a communication apparatus in a wideband wireless optical communication system based on a free space and a transmission and reception method using the same.

(b) Description of the Related Art

Free Space Optic (FSO), that is, wireless optical communication technology based on a free space rather than optical fiber, has been developed for the military, but has recently been in the spotlight as means for replacing a wired network when the wired network is damaged by terrorist acts, etc.

FSO is advantageous in that installation is easy, wideband transmission is possible, an unlicensed frequency bandwidth is used, wiretapping is impossible, and communication is guaranteed even when electromagnetic waves are disturbed in an emergency.

Most FSO-related devices reported so far, however, perform transmission using about a 1 Gbps band within several hundred meters because the transmission margin of the FSO-related device is sharply decreased by a change of a climatic environment, such as fog and rainfall. In the worst climatic conditions, communication quality is sharply deteriorated. In addition, an additional loss can occur due to a change of atmospheric density and a temperature difference.

Accordingly, there is a need for new FSO technology capable of increasing a transmission distance and guaranteeing a bandwidth having several tens of Gbps or more.

### SUMMARY OF THE INVENTION

The present invention has been made in an effort to provide a communication apparatus in a wideband wireless optical communication system based on a free space, and a transmission and reception method using the same having advantages of an improved transmission distance and wideband.

According to an embodiment of the present invention, there is provided a communication apparatus for transmitting and receiving signals to and from a central office terminal (COT) in a wireless optical communication system performing communication based on a free space, including: a wireless optical transmission/reception unit configured to process only an optical signal corresponding to a predetermined unique wavelength from among optical signals received in a first direction or a second direction opposite to the first direction and output the processed optical signal, and optical signals corresponding to a plurality of wavelengths in the first direction and the second direction; an orthogonal frequency division multiplexing (OFDM) processing unit configured to transform an electrical signal, corresponding to the optical signal of the unique wavelength received from the wireless optical transmission/reception unit, into a signal of a frequency domain corresponding to a plurality of subcarriers, and output packet data mapped to each subcarrier; and a packet processing unit configured to transfer the packet data received from the OFDM processing unit to a subscriber terminal and output outgoing packet data to the OFDM processing unit.

The wireless optical transmission/reception unit may include: a first receiver configured to receive an optical signal in the first direction; a first transmitter configured to send an optical signal in the second direction; a second receiver configured to receive an optical signal in the second direction; a second transmitter configured to send an optical signal in the first direction; a beam monitoring controller configured to monitor the optical signals inputted to the first receiver and the second receiver; and a selector configured to transfer the optical signal received from the first receiver to the OFDM processing unit through a first path or transfer the optical signal received from the second receiver to the OFDM processing unit through a second path based on a result of the monitoring of the beam monitoring controller.

The selector may transfer the outgoing packet data received from the packet processing unit to the first transmitter and the second transmitter, the first transmitter may process the outgoing packet data into an optical signal and send the processed optical signal in the second direction, and the second transmitter may process the outgoing packet data into an optical signal and send the processed optical signal in the first direction.

The beam monitoring controller may monitor the optical signal inputted to the first receiver and output a control signal to the selector so that the selector switches a reception path from the first path to the second path if, as a result of the monitoring, a value of the monitored optical signal is a predetermined reference value or lower. The beam monitoring controller may monitor the optical signal inputted to the second receiver and output a control signal to the selector so that the selector switches a reception path from the second path to the first path if, as a result of the monitoring, a value of the monitored optical signal is a predetermined reference value or lower.

Each of the first receiver and the second receiver may include: a reception module configured to receive the optical signals; a filter module configured to drop only the optical signal corresponding to the unique wavelength from among the received optical signals, and bypass optical signals corresponding to remaining wavelengths; a splitter configured to split the optical signals bypassed by the filter module and transfer the split optical signals to the first transmitter and the second transmitter; and a signal conversion module configured to convert the optical signal dropped by the filter module into the electrical signal and output the electrical signal to the selector.

Each of the first transmitter and the second transmitter may include a signal conversion module configured to convert the electrical signal received from the selector into the optical signal of the unique wavelength; a wavelength addition module configured to add the optical signal of the unique wavelength received from the signal conversion module and the optical signal received from the splitter and output the added signal; and a transmission module configured to send the optical signal received from the wavelength addition module in a beam form.

The OFDM processing unit may include: a signal conversion and processing unit configured to convert the optical signal received from the wireless optical transmission/reception unit into a digital signal, output the digital signal, convert a received digital signal into an analog signal, and output the analog signal to the wireless optical transmission/reception unit; a fast Fourier transform (FFT)/inverse fast Fourier transform (IFFT) processor configured to transform the optical signal received from the signal conversion and processing unit into a signal of a frequency domain by performing FFT on the received optical signal, output the signal of the frequency domain, transform a received signal of a frequency domain into a digital signal of a time domain by performing IFFT on the received signal, and output the digital signal of the time domain to the signal conversion and processing unit; and a subcarrier mapping processor configured to map the signal of the frequency domain received from the FFT/IFFT processor to the packet data by subcarriers, output the packet data, map the outgoing packet data received from the packet processing unit to subcarriers, and output the subcarriers.

The packet processing unit may include: a controller configured to collect pieces of information about resources, a path, and traffic received from the subcarrier mapping processor through a predetermined subcarrier, send the pieces of information to the COT, and perform path control based on path control information received from the COT through the predetermined subcarrier; a subscriber matching unit configured to send received incoming packet data to a corresponding subscriber terminal and output outgoing packet data; and a packet transfer layer processor configured to transfer packet data received from the subcarrier mapping processor to the subscriber matching unit as the incoming packet data, and transfer the outgoing packet data received from the subscriber matching unit to the subcarrier mapping processor in response to the path control of the controller.

According to another embodiment of the present invention, there is provided a communication apparatus for transmitting and receiving signals to and from a plurality of remote terminal in a wireless optical communication system performing communication based on a free space, wherein the plurality of remote terminals are arranged in a ring form around the communication apparatus, and the communication apparatus includes: a wireless optical transmission/reception unit configured to split optical signals received in a first direction or a second direction opposite to the first direction by wavelengths, output the split optical signals, and transmit the optical signals having the plurality of wavelengths in the first direction and the second direction; an orthogonal frequency division multiplexing (OFDM) processing unit configured to convert electrical signals corresponding to the optical signals received from the wireless optical transmission/reception unit into signals of a frequency domain each having a plurality of subcarriers by the wavelengths and output packet data mapped to each of the subcarriers; and a packet optical integration and transfer unit configured to collect pieces of information about resources, a path, and traffic for the plurality of remote terminals based on the packet data received from the OFDM processing unit by the wavelengths, analyze the pieces of information about resources, a path, and traffic, generate path control information based on a result of the analysis, and provide the generated path control information to the OFDM processing unit so that the generated path control information is transferred to the plurality of remote terminals.

The wireless optical transmission/reception unit may include: a first receiver configured to receive an optical signal in the first direction; a first transmitter configured to send an optical signal in the second direction; a second receiver configured to receive an optical signal in the second direction; a second transmitter configured to send an optical signal in the first direction; a beam monitoring controller configured to monitor the optical signals inputted to the first receiver and the second receiver; and a selector configured to transfer the optical signal received from the first receiver to the OFDM processing unit through a first path or transfer the optical signal received from the second receiver to the OFDM processing unit through a second path based on a result of the monitoring of the beam monitoring controller.

The packet optical integration and transfer unit may provide the packet data for each remote terminal to the wireless optical transmission/reception unit through the OFDM processing unit, the selector of the wireless optical transmission/reception unit may transfer the received packet data for each remote terminal to the first transmitter and the second transmitter, the first transmitter may process the packet data into an optical signal and send the processed optical signal in the second direction, and the second transmitter may process the packet data into an optical signal and send the processed optical signal in the first direction.

Each of the first receiver and the second receiver may include: a reception module configured to receive optical signals; a demultiplexing (DMUX) module configured to split the received optical signals by wavelengths and output the split optical signals; and a signal conversion module configured to convert the optical signal for each wavelength into an electrical signal and output the electrical signal to the selector.

Each the first transmitter and the second transmitter may include: a signal conversion module configured to convert a signal corresponding to packet data for each remote terminal received from the selector into an optical signal corresponding to a wavelength for each remote terminal; a multiplexing (MUX) module configured to multiplex the optical signals received from the signal conversion module and output the multiplexed signals; and a transmission module configured to send the optical signals received from the MUX module in a beam form.

The OFDM processing unit may include: a signal conversion and processing unit configured to convert the optical signal received from the wireless optical transmission/reception unit into a digital signal, output the digital signal, convert a received digital signal into an analog signal, and output the analog signal to the wireless optical transmission/reception unit; a fast Fourier transform (FFT)/inverse fast Fourier transform (IFFT) processor configured to transform the optical signal received from the signal conversion and processing unit into a signal of a frequency domain by performing FFT on the received optical signal, output the signal of the frequency domain, transform a received signal of a frequency domain into a digital signal of a time domain by performing IFFT on the received signal, and output the digital signal of the time domain to the signal conversion and processing unit; and a subcarrier mapping processor configured to map the signal of the frequency domain received from the FFT/IFFT processor to the packet data by subcarriers, output the packet data, map the outgoing packet data received from the packet processing unit to subcarriers, and output the subcarriers.

The optical packet integration and transfer unit may include a network management controller configured to collect pieces of information about resources, a path, and traffic received from the subcarrier mapping processor through predetermined subcarriers by the remote terminals, generate the path control information based on the pieces of information about resources, a path, and traffic for the remote terminals, and transfer the generated path control information to each of the remote terminals through the predetermined subcarrier.

The optical packet integration and transfer unit may further include: a packet transfer layer processor configured to forward the packet data received from the subcarrier mapping processor; a switching fabric unit configured to perform a packet switching function; an optical transfer layer processor configured to perform optical transport network (OTN) matching with the packet data received through the switching fabric unit; and a packet optical transfer controller configured to control the packet transfer layer processor, the switching fabric unit, and the optical transfer layer processor based on the path control information so that the OTN matching is performed, and transfer outgoing packet data from each remote terminal to the OFDM processing unit.

According to yet another embodiment of the present invention, there is provided a method of a communication apparatus transmitting and receiving optical signals in a wireless optical communication system in which communication is performed based on a free space and a plurality of the communication apparatuses is arranged in a ring form around a central office terminal (COT), including: monitoring optical signals received in a first direction or in a second direction opposite to the first direction and selecting a first path through which the optical signals in the first direction are received, and a second path through which the optical signals in the second direction are received based on a result of the monitoring; converting an optical signal having a predetermined unique wavelength from among the optical signals received through the selected path into an electrical signal; sending optical signals having remaining wavelengths other than the optical signal having the unique wavelength from among the optical signals received through the selected path in the first direction and the second direction; and transforming the optical signal of the unique wavelength converted into the electrical signal into a signal of a frequency domain having a plurality of subcarriers, and obtaining packet data mapped to the subcarriers.

The method may further include sending pieces of information about resources, a path, and traffic transferred through a predetermined subcarrier from among the subcarriers to the COT, and setting up a path based on path control information received from the COT through the predetermined subcarrier.

The method may further include: mapping outgoing packet data to each of the subcarriers; transforming the outgoing packet data mapped to the subcarriers into a signal of a time domain; converting the signal of the time domain into the optical signal corresponding to the unique wavelength; and sending the optical signal in the first direction and the second direction.

According to yet another embodiment of the present invention, there is provided a method of a communication apparatus transmitting and receiving optical signals in a wireless optical communication system in which communication is performed based on a free space and a plurality of remote terminals are arranged in a ring form around a communication apparatus, including: monitoring optical signals received in a first direction or in a second direction opposite to the first direction, and selecting a first path through which the optical signals in the first direction are received and a second path through which the optical signals in the second direction are received based on a result of the monitoring; splitting the optical signals received through the selected path by wavelengths corresponding to the respective remote terminals and converting each of the optical signals for each wavelength into an electrical signal; transforming the optical signal converted into the electrical signal into a signal of a frequency domain having a plurality of subcarriers by the wavelength and obtaining packet data mapped to each of the subcarriers; and setting up a path for each of the plurality of remote terminals based on pieces of information about resources, a path, and traffic received through a predetermined subcarrier, from among the subcarriers for each wavelength.

The method may further include: mapping outgoing packet data for each remote terminal to a subcarrier; transforming the outgoing packet data mapped to the subcarrier into a signal of a time domain; converting the signal of the time domain into an optical signal having a wavelength corresponding to each of the remote terminals; and sending the optical signals in the first direction and the second direction.

### BRIEF DESCRIPTION OF THE DRAWINGS

FIG. 1 is a diagram showing the structure of a wideband wireless optical communication system in accordance with an exemplary embodiment of the present invention.

FIG. 2 shows a schematic structure of a remote terminal (RT) in accordance with an exemplary embodiment of the present invention, and FIG. 3 is a diagram showing a detailed structure of the RT.

FIG. 4 is a flowchart illustrating the reception method of the RT in accordance with an exemplary embodiment of the present invention.

FIG. 5 is a flowchart illustrating the transmission method of the RT in accordance with an exemplary embodiment of the present invention.

FIG. 6 is a diagram showing a schematic structure of a central office terminal (COT) in accordance with an exemplary embodiment of the present invention, and FIG. 7 is a diagram showing a detailed structure of the COT.

FIG. 8 is a flowchart illustrating the reception method of the COT in accordance with an exemplary embodiment of the present invention.

FIG. 9 is a flowchart illustrating the transmission method of the COT in accordance with an exemplary embodiment of the present invention.

### DETAILED DESCRIPTION OF THE EMBODIMENTS

In the following detailed description, only certain exemplary embodiments of the present invention have been shown and described, simply by way of illustration. As those skilled in the art would realize, the described embodiments may be modified in various different ways, all without departing from the spirit or scope of the present invention. Accordingly, the drawings and description are to be regarded as illustrative in nature and not restrictive. Like reference numerals designate like elements throughout the specification.

In the entire specification, unless explicitly described to the contrary, the word “comprise” and variations such as “comprises” or “comprising” will be understood to imply the inclusion of stated elements but not the exclusion of any other elements.

A communication apparatus in a wideband wireless optical communication system and a transmission and reception method using the same in accordance with exemplary embodiments of the present invention are described below.

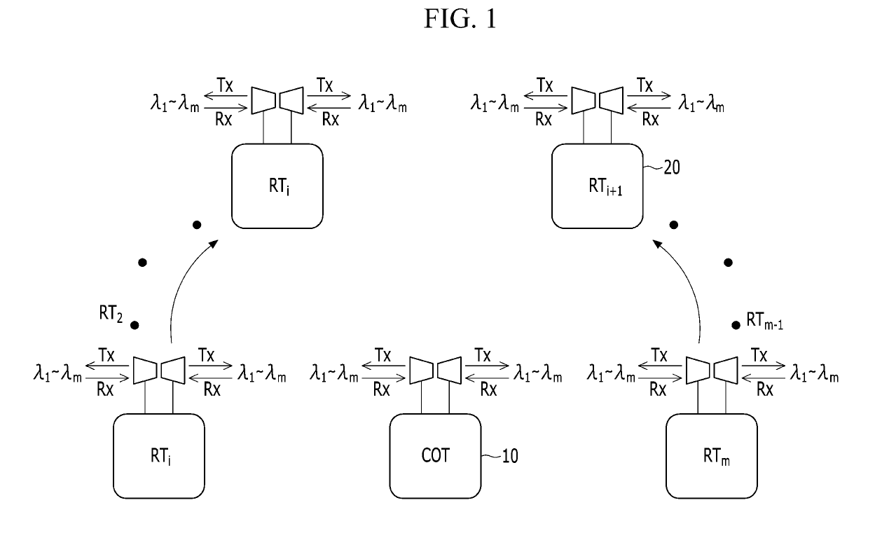

FIG. 1 is a diagram showing the structure of a wideband wireless optical communication system in accordance with an exemplary embodiment of the present invention.

As shown in FIG. 1, the wideband wireless optical communication system 1 in accordance with an exemplary embodiment of the present invention includes a central office terminal (COT) 10, that is, a communication apparatus functioning as a central processing terminal, and a plurality of remote terminals (RTs) (assigned a representative reference number 20), that is, communication apparatuses functioning as remote terminals.

The plurality of RTs RT₁, RT₂, . . . , RTᵢ, RTᵢ₊₁, . . . , RTₘ₋₁, and RTₘ are coupled in a ring form. In particular, the plurality of RTs are bi-directionally coupled in a ring form around the COT 10.

The RT 20 is classified according to a unique wavelength λi. Here, a plurality of unique wavelengths may be allocated to one RT according to traffic conditions. A wavelength λ includes a plurality of subcarriers, and a specific subcarrier is allocated for the resource information and FSO beam information of the RT. A subcarrier f0, from among a plurality of subcarriers f0, f1, f2, f3, . . . , fm in each wavelength, contains pieces of information about real-time resources, a path, and traffic for each RT.

The COT 10 analyzes RT resources and statistical data received from each RT through subcarriers, determines optimal path information based on a result of the analysis, and sends the determined path information to the RT 20. The RT 20 can perform path setting, the release of a path, and a change of a path based on the path information.

An optical signal is transmitted uni-directionally along the wireless optical ring in this ring-shaped structure. The COT 10 can perform wireless optical transmission and reception to and from adjacent RTs (e.g., RT₁ and RTₘ) at the same time, and the RT 20 can perform wireless optical transmission and reception to and from adjacent RTs or the COT 10 at the same time.

The COT 10 bi-directionally sends optical signals corresponding to all wireless optical wavelengths to adjacent RTs (e.g., RT₁ and RTₘ). The RT 20 drops an optical signal corresponding to a unique wavelength, from among the received optical signals, and bypasses optical signals corresponding to remaining wavelengths.

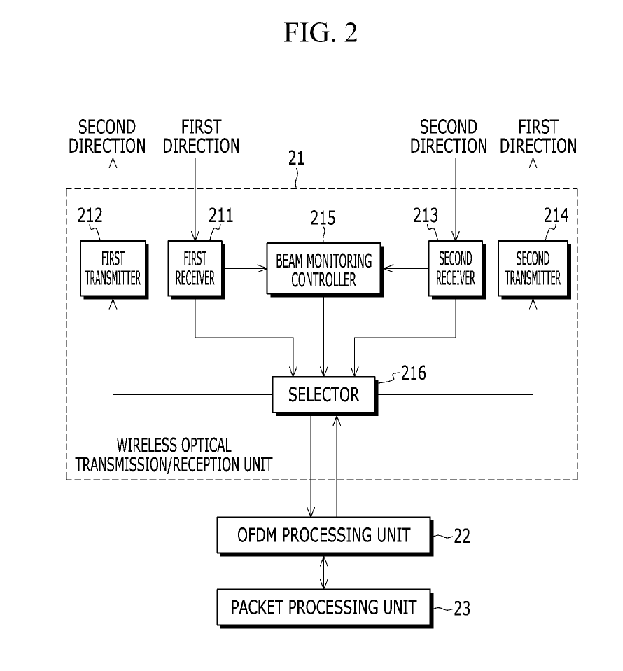

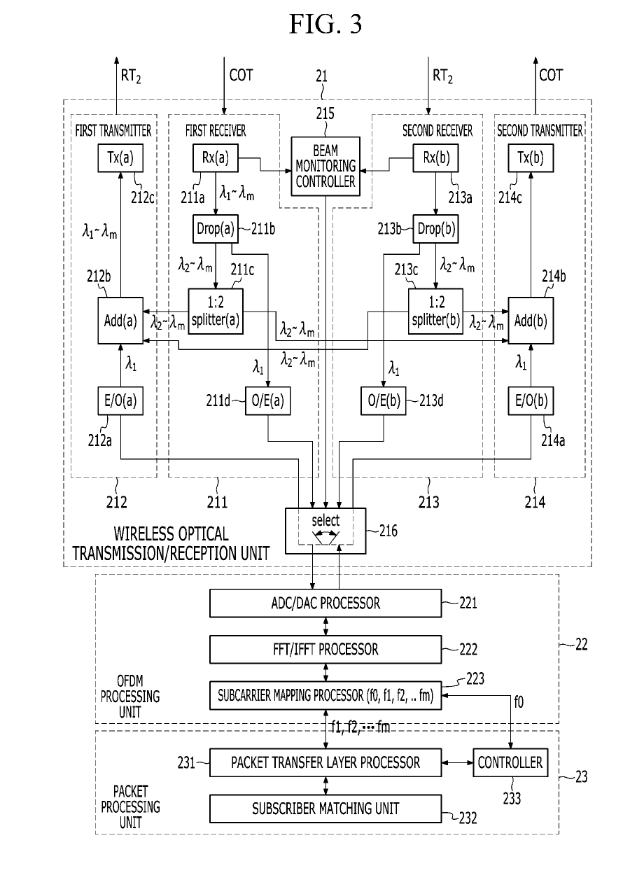

FIG. 2 shows a schematic structure of the RT in accordance with an exemplary embodiment of the present invention.

As shown in FIG. 2, the RT 20 in accordance with an exemplary embodiment of the present invention includes a wireless optical transmission/reception unit 21, an orthogonal frequency division multiplexing (OFDM) processing unit 22, and a packet processing unit 23. For better comprehension and ease of description, an RT in accordance with an exemplary embodiment of the present invention is described below by taking the RT₁ from among the plurality of RTs as an example. It is assumed that a shared wavelength λ₁ has been allocated to the RT₁.

The wireless optical transmission/reception unit 21, as shown in FIG. 2, includes duplexed optical transmitters/receivers, that is, a first receiver 211 and a first transmitter 212, and a second receiver 213 and a second transmitter 214, and further includes a beam monitoring controller 215 and a selector 216.

The first receiver 211 receives an optical signal in a first direction, and the first transmitter 212 sends an optical signal in a second direction. Furthermore, the second receiver 213 receives an optical signal in the second direction, and the second transmitter 214 sends an optical signal in the first direction.

The beam monitoring controller 215 monitors optical signals inputted to the first and second receivers 211 and 213 and sends a control signal to the selector 216 based on a result of the monitoring. More particularly, when a value of an optical signal inputted to the first receiver 211 is a predetermined reference value or lower, the beam monitoring controller 215 outputs a control signal to the selector 216 so that the selector 216 switches the reception path from a first path to a second path. Furthermore, the beam monitoring controller 215 monitors an optical signal inputted to the second receiver 213. When a value of the optical signal is a predetermined reference value or lower, the beam monitoring controller 215 outputs a control signal to the selector 216 so that the selector 216 switches the reception path from the second path to the first path. Here, the first path refers to a path along which the selector 216 is supplied with an optical signal received via the first receiver 211, and the second path refers to a path along which the selector 216 is supplied with an optical signal received via the second receiver 213. Even if an obstacle is generated, a path can be switched from the first path to the second path or from the second path to the first path based on a result of the monitoring of the beam monitoring controller 215. Accordingly, optical signals can be transmitted and received without disconnection in a wireless optical signal path.

The selector 216 selects the first path or the second path as a reception path in response to the control signal of the beam monitoring controller 215 and transfers an optical signal received via the selected path to the OFDM processing unit 22. In contrast, an outgoing packet received from the OFDM processing unit 22 is transferred to all duplexed optical transmission paths. That is, the outgoing packet is transferred to both the first transmitter 112 and the second transmitter 114.

FIG. 3 is a diagram showing a detailed structure of the RT.

For this reception processing, the first and second receivers 211 and 213, as shown in FIG. 3, include respective reception modules 211a and 213a (also called Rx(a) and Rx(b)) configured to receive optical signals, respective filter modules 211b and 213b (also called Drop(a) and Drop(b)) configured to only drop optical signals corresponding to unique wavelengths allocated thereto from among the received optical signals and bypass optical signals corresponding to the remaining wavelengths, respective splitters 211c and 213c (also called 1:2 Splitter(a) and 1:2 Splitter(b)) configured to split the optical signals bypassed by the filter modules and transfer the split signals to the first and second transmitters 212 and 214, and respective signal conversion modules 211d and 213d (also called O/E(a) and O/E(b)) configured to convert the optical signals dropped by the filter modules 211b and 213b into electrical signals and output the electrical signals to the selector 216. Here, each of the filter modules 211b and 213b can be formed of a thin film filter. The splitters 211c and 213c can be formed of 1:2 splitters. The splitters 211c and 213c transfer some of the split optical signals to the first transmitter 212 and transfer the remaining split optical signals to the second transmitter 214.

Meanwhile, the first and second transmitters 212 and 214 include respective signal conversion modules 212a and 214a (also called E/O(a) and E/O(b)) configured to convert electrical signals received from the selector 216 into optical signals, respective wavelength addition modules 212b and 214b (also called Add(a) and Add(b)) configured to add optical signals corresponding to transmission wavelengths (corresponding to unique wavelengths received from the signal conversion modules 212a and 214a or optical signals received from the splitters 211c and 213c of the first and second receivers) and output the added optical signals, and respective transmission modules 212c and 214c (also called Tx(a) and Tx(b)) configured to output the optical signals received from the wavelength addition modules 212b and 214b in the form of beams.

Meanwhile, the OFDM processing unit 22 and the packet processing unit 23 can be configured as follows.

The OFDM processing unit 22, as shown in FIG. 3, includes an analog to digital converting (ADC)/digital to analog converting (DAC) processor 221, a fast Fourier transform (FFT)/inverse fast Fourier transform (IFFT) processor 222, and a subcarrier mapping processor 223.

The ADC/DAC processor 221 (called a signal conversion and processing unit) converts a signal received from the wireless optical transmission/reception unit 21 into a digital signal and outputs the digital signal. Furthermore, the ADC/DAC processor 221 converts a signal received from the FFT/IFFT processor 222 into an analog signal and outputs the analog signal to the wireless optical transmission/reception unit 21.

The FFT/IFFT processor 222 receives a digital signal from the ADC/DAC processor 221, performs FFT on the digital signal, that is, transforms the digital signal into a signal of a frequency domain, and outputs the transformed signal. Furthermore, the FFT/IFFT processor 222 performs IFFT on a signal of a frequency domain received from the subcarrier mapping processor 223, that is, transforms the signal of a frequency domain into a signal of a time domain, and outputs the transformed signal to the ADC/DAC processor 221.

The subcarrier mapping processor 223 maps the signal of a frequency domain received from the FFT/IFFT processor 222 to packet data for each subcarrier, and outputs the mapped packet data. Furthermore, the subcarrier mapping processor 223 maps packet data received from the packet processing unit 23 to a subcarrier and outputs the subcarrier.

Meanwhile, the packet processing unit 23, as shown in FIG. 3, includes a packet transfer layer processor 231, a subscriber matching unit 232, and a controller 233.

The packet transfer layer processor 231 receives incoming packet data from a corresponding RT, for example, an RT₁ subscriber, through the subcarrier mapping processor 223, and transfers the incoming packet data to the subscriber matching unit 232. Furthermore, the packet transfer layer processor 231 receives outgoing packet data from the RT₁ subscriber via the subscriber matching unit 232, and transfers the outgoing packet data to the subcarrier mapping processor 223.

The subscriber matching unit 232 sends incoming packet data to a corresponding subscriber (e.g., an RT₁ subscriber), and transfers outgoing packet data received from a subscriber to the packet transfer layer processor 231. A multi-protocol label switching-transporting profile (MPLS-TP) packet engine is mounted on the packet transfer layer processor 231, and the subscriber matching unit 232 accommodates a subscriber Ethernet port.

The controller 233 receives optimum path control information from the COT 10, sets or releases a packet path based on the optimum path control information, and transfers a corresponding path control signal to the packet transfer layer processor 231. This controller 233 can perform an MPLS-TP and Ethernet protocol signaling functions.

Meanwhile, the subcarrier mapping processor 223 transfers a subcarrier f0 from among subcarriers to the controller 233, and transfers the remaining subcarriers f1 to fm to the packet transfer layer processor 231. The controller 233 manages a mapping table between packet data and subcarriers, collects and analyzes pieces of information about resources, a path, and traffic (e.g., information about the RT₁) in real time so that centralized network management is possible, loads the pieces of information on to a subcarrier (e.g., the subcarrier f0 of the RT₁), and transfers the subcarrier to the COT 10. Next, the COT 10 sets an optimum path for each RT user based on pieces of information about the resources, a path, and traffic of all RTs and the COT, and transfers corresponding optimum path control information to each RT.

The transmission and reception methods of the RT configured as described above in accordance with exemplary embodiments of the present invention are described below.

Hereinafter, the transmission and reception methods of the RT in accordance with exemplary embodiments of the present invention are described by taking the RT₁ from among a plurality of RTs as an example. It is assumed that a shared wavelength λ₁ has been allocated to the RT₁.

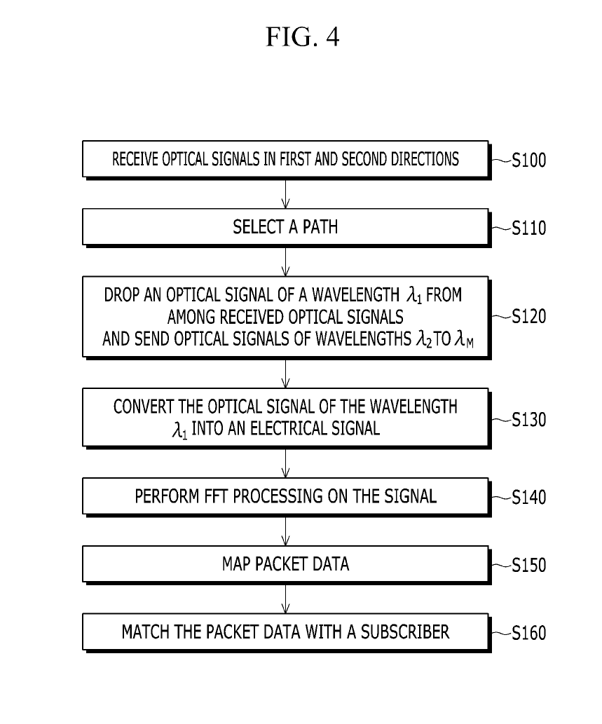

FIG. 4 is a flowchart illustrating the reception method of the RT in accordance with an exemplary embodiment of the present invention.

The first receiver 211 of the RT 20 receives an optical signal in a first direction (e.g., a COT direction), and the second receiver 213 receives an optical signal in a second direction (e.g., an RT₂ direction) at step S100.

The reception module 211a of the first receiver 211 outputs the optical signal to the filter module 211b and the beam monitoring controller 215, and the reception module 213a of the second receiver 213 outputs the optical signal to the filter module 213b and the beam monitoring controller 215.

The beam monitoring controller 215 monitors the optical signals received from the first receiver 211 and the second receiver 213, and selects a first path or a second path based on a result of the monitoring at step S110.

If, as a result of the monitoring, the first path is selected, the optical signal from the COT 10 received by the first receiver 211 is transferred to the OFDM processing unit 22 via the selector 216. If, as a result of the monitoring, the second path is selected, the optical signal from the RT₂ received by the second receiver 213 is transferred to the OFDM processing unit 22 via the selector 216.

For example, if the first path is selected, optical signals λ₁ to λₘ for respective wavelengths received from the COT 10 are filtered by the filter module 211b of the first receiver 211. That is, the optical signal of the wavelength λ₁ corresponding to the RT₁ is dropped and then inputted to the signal conversion module 211d. The optical signals of the remaining wavelengths λ₂ to λₘ are split by the splitter 211c and then transferred to the wavelength addition module 212b of the first transmitter 212 and the wavelength addition module 214b of the second transmitter 214.

The first transmitter 212 outputs the optical signals of the remaining wavelengths λ₂ to λₘ in the second direction, that is, to the RT₂. Furthermore, the second transmitter 214 outputs the optical signals of the remaining wavelengths λ₂ to λₘ in the first direction, that is, to the COT 10. Here, each of the first transmitter 212 and the second transmitter 214 adds the optical signal of the unique wavelength λ₁ of the RT₁ to the optical signals λ₂ to λₘ and outputs the resulting signals. Accordingly, the optical signals λ₂ to λₘ of all the wavelengths are transferred bi-directionally at step S120.

The signal conversion module 211d converts the optical signal of the wavelength λ₁ into an electrical signal at step S130. The electrical signal corresponding to the wavelength λ₁ is transferred to the OFDM processing unit 22 via the selector 216. The OFDM processing unit 22 converts the electrical signal into a digital signal, transforms the digital signal into a signal of a frequency domain at step S140, maps the transformed signal to packet data for each subcarrier in response to control according to a mapping table supplied from the controller 233, and outputs the packet data at step S150.

From among the subcarriers, the subcarrier f0 is transferred to the controller 233 of the packet processing unit 23. Packet data corresponding to the remaining subcarriers f1 to fm, that is, incoming packet data, is transferred to the packet transfer layer processor 231 of the packet processing unit 23. The incoming packet data is transferred to a subscriber through the packet transfer layer processor 231 and the subscriber matching unit 232 at step S160.

Meanwhile, if the first path is selected, likewise, the optical signal of the unique wavelength λ₁ of the RT₁, from among the optical signals λ₁ to λₘ for the respective wavelengths received from the RT₂, is dropped, converted into an electrical signal, and then transferred to the OFMD processing unit 22 via the selector 216. Next, the OFDM processing unit 22 transforms an electrical signal, corresponding to the optical signal of the wavelength λ₁ received from the RT₂, into a signal of a frequency domain by performing FFT on the electrical signal, and transfers packet data mapped to a subcarrier of the frequency domain to the packet processing unit 23 so that the incoming packet data from the RT₂ is delivered to a subscriber.

Even in this case, the first transmitter 212 sends the optical signals of the wavelengths λ₂ to λₘ, from among the optical signals of the wavelengths λ₁ to λₘ received from the RT₂, in the second direction, that is, to the RT₂. The second transmitter 214 sends the optical signals of the wavelengths λ₂ to λₘ in the first direction, that is, to the COT 10.

Since a wireless optical signal is bi-directionally transmitted along the ring through this reception process, a corresponding wavelength can be dropped from an optical signal received in an opposite direction even when the optical signal is not detected in a specific section, and thus a packet can be subject to incoming processing.

If an obstacle is encountered in a wireless optical transfer network due to birds or other obstacles hindering the transfer of a wireless optical signal, the beam monitoring controller 215 can detect the occurrence of this obstacle, so the first path can be switched to the second path or the second path can be switched to the first path. Although an obstacle occurs, automatic path switching is performed without breaking a wireless optical signal path. Accordingly, a wireless optical signal can be normally transmitted or received.

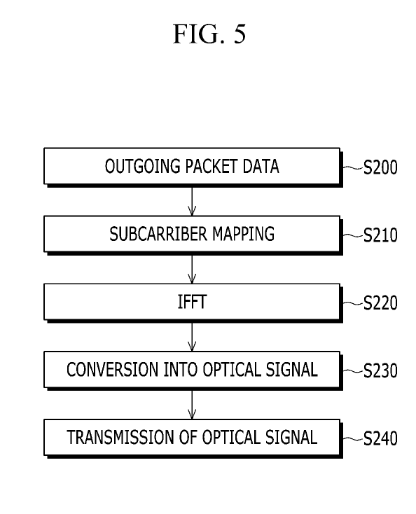

FIG. 5 is a flowchart illustrating the transmission method of the RT in accordance with an exemplary embodiment of the present invention.

If the RT 20 seeks to send data, outgoing packet data generated from the packet processing unit 23 is transferred to the OFDM processing unit 22. The OFDM processing unit 22 maps the outgoing packet data to each subcarrier at steps S200 and S210. The signals of a frequency domain are transformed into signals of a time domain through IFFT processing, converted into analog signals, and then transferred to the wireless optical transmission/reception unit 21 at step S220.

The wireless optical transmission/reception unit 21 converts the signals received from the OFDM processing unit 22 into optical signals at step S230. Particularly, the wireless optical transmission/reception unit 21 converts the received signal into an optical signal corresponding to a unique wavelength λ₁ for the RT₁ at step S240. Here, the signal conversion modules 212a and 214a of the first and second transmitters 212 and 214 of the wireless optical transmission/reception unit 21 convert electrical signals into optical signals, and transfer the optical signals to the wavelength addition modules 212b and 214b. The wavelength addition modules 212b and 214b transfer the optical signals to the transmission modules 212c and 214c.

Here, the wavelength addition module 212b of the first transmitter 212 can transfer the optical signal corresponding to the wavelength λ₁ received from the signal conversion module 212a and the optical signals corresponding to the wavelengths λ₂ to λₘ received from the splitter 211c of the first receiver 211 or the optical signals corresponding to the wavelengths λ₂ to λₘ received from the splitter 213c of the second receiver 213 to the transmission module 212c. Furthermore, the wavelength addition module 214b of the second transmitter 214 can transfer the optical signal corresponding to the wavelength λ₁ received from the signal conversion module 214a and the optical signals corresponding to the wavelengths λ₂ to λₘ received from the splitter 211c of the first receiver 211 or the optical signals corresponding to the wavelengths λ₂ to λₘ received from the splitter 213c of the second receiver 213 to the transmission module 214c.

When packet data is transmitted as described above, a corresponding wavelength is added to the packet data and transmitted bi-directionally. Accordingly, packet data can be transmitted and received and automatically switched without losing the packet data in the wireless optical ring.

The structure of the COT in accordance with an exemplary embodiment of the present invention is described below.

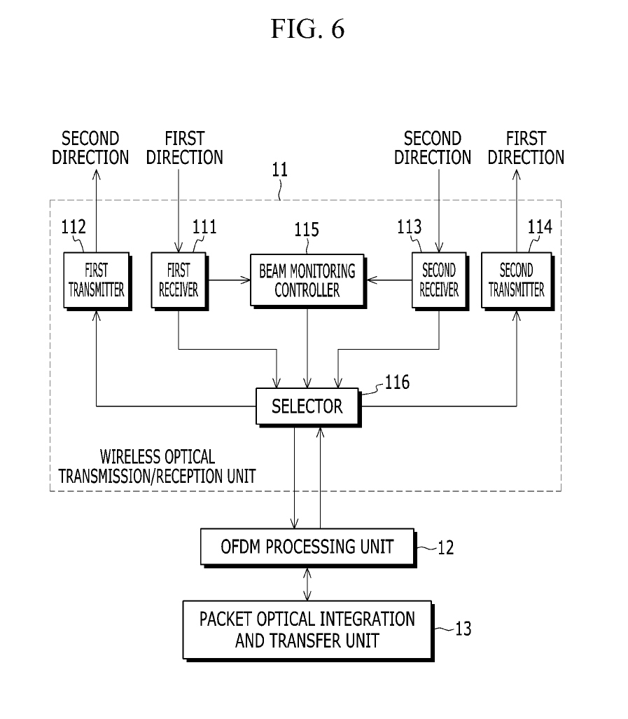

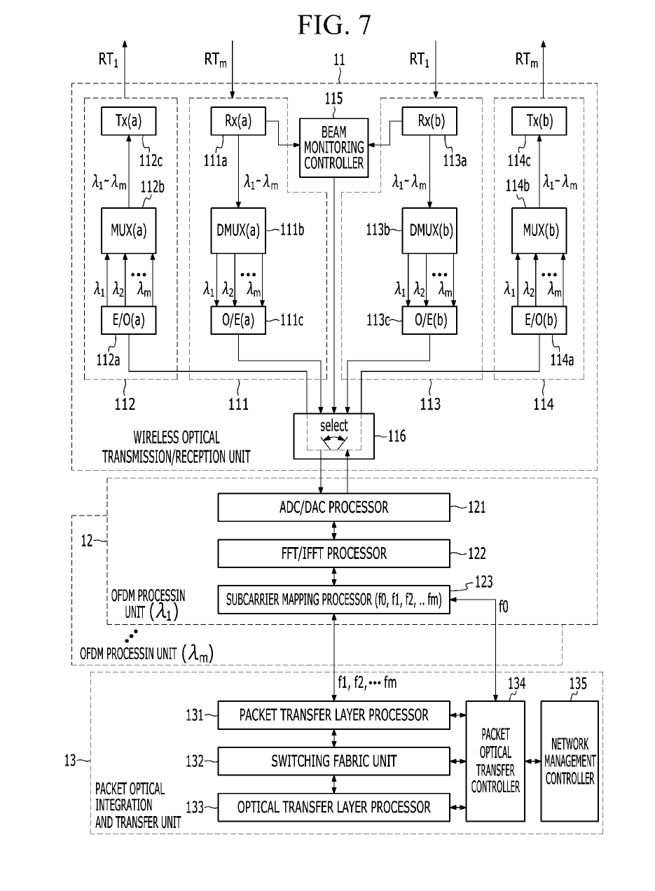

FIG. 6 is a diagram showing a schematic structure of the COT in accordance with an exemplary embodiment of the present invention.

As shown in FIG. 6, the COT 10 in accordance with an exemplary embodiment of the present invention includes a wireless optical transmission/reception unit 11, an OFDM processing unit 12, and a packet optical integration and transfer unit 13.

The wireless optical transmission/reception unit 11 includes duplexed optical transmitters/receivers, that is, a first receiver 111 and a first transmitter 112, a second receiver 113 and a second transmitter 114, and further includes a beam monitoring controller 115 and a selector 116.

The first receiver 111 receives an optical signal in a first direction, and the first transmitter 112 sends an optical signal in a second direction. Furthermore, the second receiver 113 receives an optical signal in the second direction, and the second transmitter 114 sends an optical signal in the first direction.

FIG. 7 is a diagram showing a detailed structure of the COT.

The reception units 111 and 113, as shown in FIG. 7, include respective reception modules 111a and 113a (also called Rx(a) and Rx(b)) configured to receive optical signals, respective DMUX modules 111b and 113b (also called DMUX(a) and DMUX(b)) configured to demultiplex the received optical signals and output the demultiplexed signals, and respective signal conversion modules 111c and 113c (also called O/E(a) and O/E(b)) configured to convert the demultiplexed signals into electrical signals and output the electrical signals to the selector 116. Here, each of the DMUX modules 111b and 113b can be formed of a thin film filter.

Meanwhile, the transmission units 112 and 114 include respective signal conversion modules 112a and 114a (also called E/O(a) and E/O(b)) configured to convert electrical signals received from the selector 116 into optical signals, respective MUX modules 112b and 114b (also called MUX(a) and MUX(b)) configured to multiplex the optical signals received from the signal conversion modules and output the multiplexed signals, and respective transmission modules 112c and 114c (also called Tx(a) and Tx(b)) configured to send the multiplexed optical signals.

The beam monitoring controller 115 monitors optical signals received from the first and second receivers 111 and 113, and sends a control signal to the selector 116 based on a result of the monitoring. More particularly, the beam monitoring controller 115 monitors an optical signal inputted to the first receiver 111. When a value of the received optical signal is a predetermined reference value or lower, the beam monitoring controller 115 outputs a control signal to the selector 116 so that the selector 116 switches the reception path from a first path to a second path. Furthermore, the beam monitoring controller 115 monitors an optical signal inputted to the second receiver 113. When a value of the received optical signal is a predetermined reference value or lower, the beam monitoring controller 115 outputs a control signal to the selector 116 so that the selector 116 switches the reception path from the second path to the first path. Here, the first path indicates a path along which the selector 116 is supplied with an optical signal received through the first receiver 111, and the second path indicates a path along which the selector 116 is supplied with an optical signal received through the second receiver 113. Even if an obstacle is generated, a path can be switched from the first path to the second path or from the second path to the first path based on a result of the monitoring of the beam monitoring controller 115. Accordingly, optical signals can be transmitted and received without disconnection in a wireless optical signal path.

The selector 116 selects the first path or the second path as a reception path in response to the control signal of the beam monitoring controller 115, and transfers an optical signal received through the selected path to the OFDM processing unit 12.

Meanwhile, the OFDM processing unit 12 and the packet optical integration and transfer unit 13 are configured as follows.

The OFDM processing unit 12, as shown in FIG. 7, includes an analog to digital converting (ADC)/digital to analog converting (DAC) processor 121, a fast Fourier transform (FFT)/inverse fast Fourier transform (IFFT) processor 122, and a subcarrier mapping processor 123. A plurality of the OFDM processing units 12 can be used in order to process signals corresponding to respective wavelengths.

The ADC/DAC processor 121 converts a signal received from the wireless optical transmission/reception unit 11 into a digital signal, and outputs the digital signal. Furthermore, the ADC/DAC processor 121 converts a signal received from the FFT/IFFT processor 122 into an analog signal, and outputs the analog signal to the wireless optical transmission/reception unit 11.

The FFT/IFFT processor 122 receives the digital signal from the ADC/DAC processor 121, performs FFT on the digital signal, that is, transforms the digital signal into a signal of a frequency domain, and outputs the signal of a frequency domain. Furthermore, the FFT/IFFT processor 122 performs IFFT on the signal of a frequency domain received from the subcarrier mapping processor 123, that is, transforms the signal of a frequency domain into a signal of a time domain, and outputs the signal of a time domain to the ADC/DAC processor 121.

The subcarrier mapping processor 123 maps the signal of a frequency domain received from the FFT/IFFT processor 122 to packet data by the subcarrier, and outputs the packet data. Furthermore, the subcarrier mapping processor 123 maps packet data received from the packet optical integration and transfer unit 13 to a subcarrier, and outputs the subcarrier.

Meanwhile, the packet optical integration and transfer unit 13, as shown in FIG. 7, includes a packet transfer layer processor 131, a switching fabric unit 132, an optical transfer layer processor 133, a packet optical transfer controller 134, and a network management controller 135.

The packet transfer layer processor 131 performs an MPLS-TP packet matching function and an MPLS-TP path setting function on packet data received from the subcarrier mapping processor 123 and a packet forwarding function on a given path. The packet transfer layer processor 131 transfers packet data for a given RT to the subcarrier mapping processor 123.

The switching fabric unit 132 performs a packet switching function within the packet optical integration and transfer unit 13, and the optical transfer layer processor 133 performs an optical transport network (OTN) matching function and a wavelength switching function.

The packet optical transfer controller 134 transmits and receives path control information in response to a packet optical transfer control signal received from the network management controller 135. Furthermore, the packet optical transfer controller 134 outputs a control signal to the packet transfer layer processor 131, the switching fabric unit 132, and the optical transfer layer processor 133, sets or releases a packet path within the COT and an optical path individually or integrally while operating in conjunction with the packet transfer layer processor 131, the switching fabric unit 132, and the optical transfer layer processor 133, and performs a path integration control protocol signaling function based on generalized multi-protocol label switching (GMPLS).

Meanwhile, a subcarrier f0, from among subcarriers received from the subcarrier mapping processor 123, is transferred to the network management controller 135, and the remaining subcarriers f1 to fm are transferred to the packet transfer layer processor 131.

The network management controller 135 collects pieces of information about resources, a path, and traffic for each RT based on the subcarrier f0 by wavelength, analyzes the pieces of information collected for the RT, determines an optimum path in all networks based on a result of the analysis, and generate corresponding optimum path control information. The generated optimum path control information is transferred to each RT through the subcarrier f0. Control signals are outputted to the packet transfer layer processor 131, the switching fabric unit 132, and the optical transfer layer processor 133, respectively, based on pieces of the optimum path control information, and the optimum path of the COT itself is automatically set or released.

The transmission and reception methods of the COT configured as described above in accordance with exemplary embodiments of the present invention are described below.

Here, an example in which the COT sends an optical signal to the RT₁ forward and sends an optical signal to the RTₘ backward is described.

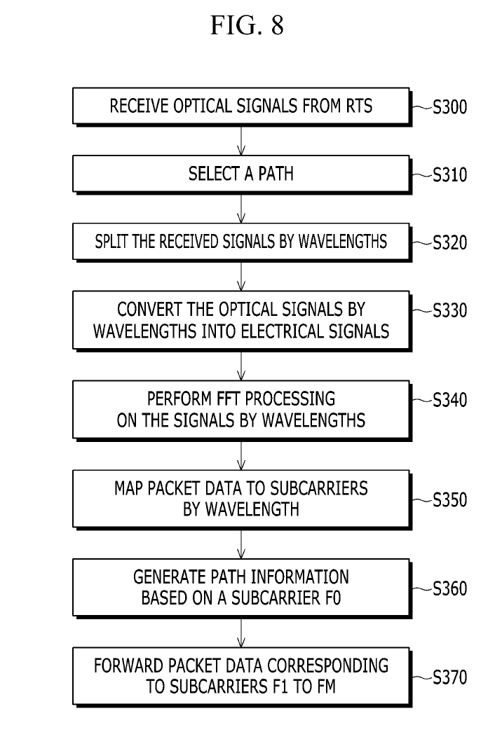

FIG. 8 is a flowchart illustrating the reception method of the COT in accordance with an exemplary embodiment of the present invention.

As shown in FIGS. 7 and 8, the first receiver 111 of the COT 10 receives an optical signal in a first direction (e.g., the direction of the RTₘ), and the second receiver 113 receives an optical signal in a second direction (e.g., the direction of the RT₁) at step S300.

The reception module 111a of the first receiver 111 outputs the optical signal to the DMUX module 111b and the beam monitoring controller 115, and the reception module 113a of the second receiver 113 outputs the optical signal to the DMUX module 113b and the beam monitoring controller 115.

The beam monitoring controller 115 monitors the optical signals received from the first receiver 111 and the second receiver 113, and selects the first path or the second path based on a result of the monitoring at step S310.

If, as a result of the monitoring, the first path is selected, the optical signal received by the first receiver 111 from the RTₘ is transferred to the OFDM processing unit 12 via the selector 116. If, as a result of the monitoring, the second path is selected, the optical signal received by the second receiver 113 from the RT₁ is transferred to the OFDM processing unit 12 via the selector 116.

If the first path is selected, the DMUX module 111b of the first receiver 111 demultiplexes the optical signals λ₁ to λₘ received from the RTₘ by wavelengths at step S320. The signal conversion module 111c converts the optical signals λ₁, λ₂, . . . , λₘ demultiplexed by wavelengths into electrical signals at step S330, and transfers the electrical signals to the OFDM processing unit 12 through the selector 116.

The OFDM processing unit 12 processes the received signals, maps packet data to the subcarriers of the processed signals, and transfers the subcarriers to the packet optical integration and transfer unit 13. That is, the OFDM processing unit 12 converts the electrical signals into digital signals by wavelengths, transforms the digital signals into signals of a frequency domain at step S340, maps packet data to the subcarriers of the signals in response to control according to a mapping table supplied from the network management controller 135, and outputs the subcarriers at step S350.

As described above, the packet data processed by the OFDM processing unit 12 by wavelengths is supplied to the packet optical integration and transfer unit 13. The subcarrier f0, from among the subcarriers, is transferred to the network management controller 135, and packet data corresponding to the remaining subcarriers is transferred to the packet transfer layer processor 131.

The network management controller 135 collects pieces of information about resources, a path, and traffic corresponding to the subcarrier f0 by wavelength, and generates path control information in all networks based on the pieces of information at step S360. Meanwhile, the packet data transferred by the packet transfer layer processor 131 is forwarded through the switching fabric unit 132 and the optical transfer layer processor 133 at step S370.

Since a wireless optical signal is bi-directionally transmitted along the ring through this reception process, a corresponding wavelength can be dropped from an optical signal received in an opposite direction even if the optical signal is not detected in a specific section, and thus a packet can be subject to incoming processing

Furthermore, if an obstacle is encountered in a wireless optical transfer network due to birds or other obstacles hindering the transfer of a wireless optical signal, the beam monitoring controller 115 can detect the occurrence of this obstacle, so the first path can be switched to the second path or the second path can be switched to the first path. Even if an obstacle occurs, automatic path switching is performed without breaking a wireless optical signal path. Accordingly, a wireless optical signal can be normally transmitted or received.

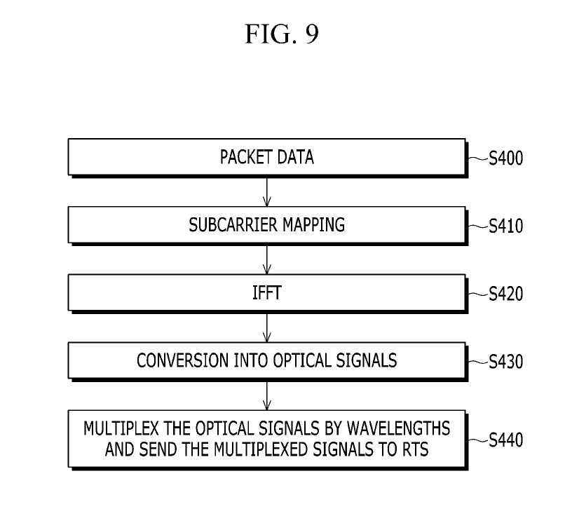

FIG. 9 is a flowchart illustrating the transmission method of the COT in accordance with an exemplary embodiment of the present invention.

If the COT 10 seeks to send data, packet data generated from the packet optical integration and transfer unit 13 is transferred to the OFDM processing unit 12. The OFDM processing unit 12 maps the outgoing packet data to each subcarrier at steps S400 and S410. The signals of a frequency domain are transformed into signals of a time domain through IFFT processing, converted into analog signals, and then transferred to the wireless optical transmission/reception unit 11 at step S420.

The wireless optical transmission/reception unit 11 converts the signals received from the OFDM processing unit 12 into optical signals at step S430. In particular, the wireless optical transmission/reception unit 11 converts the received signals into the optical signals corresponding to the respective wavelengths λ₁, λ₂, . . . , λₘ and sends the optical signals at step S440. Here, the signal conversion modules 112a and 114a of the first and second transmitters 112 and 114 of the wireless optical transmission/reception unit 11 convert the electrical signals into the optical signals by wavelengths, and transfer the optical signals to the MUX modules 112b and 114b. The MUX modules 112b and 114b multiplex the received optical signals and transfer the multiplexed signals to the transmission modules 112c and 114c.

In accordance with an exemplary embodiment of the present invention, a sharp decrease in a transmission margin due to a climatic change, such as fog and rainfall, can be compensated for by transmitting/receiving signals by applying orthogonal frequency division multiplexing (OFDM) technology to FSO in which communication is performed based on a free space. Furthermore, wideband transmission is possible by applying wavelength division multiplexing (WDM) technology to FSO.

Furthermore, in a system configured to have a ring structure, the communication apparatus adds or drops only an optical signal corresponding to a unique wavelength from among optical signals transmitted along the ring. Accordingly, the speed of a wireless optical transfer network can be increased, and the structure of a wireless optical transfer network can be simplified. Furthermore, when a wireless section is damaged, a wireless optical transfer path can be automatically switched without data loss.

The exemplary embodiments of the present invention are not implemented only using the aforementioned method and apparatus, but may be implemented using a program for realizing a function corresponding to the construction according to the exemplary embodiment of the present invention or a recording medium on which the program is recorded.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

What is claimed is:

1. A communication apparatus for transmitting and receiving signals to and from a central office terminal (COT) in a wireless optical communication system performing communication based on a free space, comprising:
a wireless optical transmission/reception unit configured to process only an optical signal corresponding to a predetermined unique wavelength from among optical signals received in a first direction or a second direction opposite to the first direction and output the processed optical signal, and optical signals corresponding to a plurality of wavelengths in the first direction and the second direction;
an orthogonal frequency division multiplexing (OFDM) processing unit configured to transform an electrical signal, corresponding to the optical signal of the unique wavelength received from the wireless optical transmission/reception unit, into a signal of a frequency domain corresponding to a plurality of subcarriers and output packet data mapped to each subcarrier; and
a packet processing unit configured to transfer the packet data received from the OFDM processing unit to a subscriber terminal and output outgoing packet data to the OFDM processing unit.

2. The communication apparatus of claim 1, wherein the wireless optical transmission/reception unit comprises:
a first receiver configured to receive an optical signal in the first direction;
a first transmitter configured to send an optical signal in the second direction;
a second receiver configured to receive an optical signal in the second direction;
a second transmitter configured to send an optical signal in the first direction;
a beam monitoring controller configured to monitor the optical signals inputted to the first receiver and the second receiver; and
a selector configured to transfer the optical signal received from the first receiver to the OFDM processing unit through a first path or transfer the optical signal received from the second receiver to the OFDM processing unit through a second path based on a result of the monitoring of the beam monitoring controller,
wherein the selector transfers the outgoing packet data received from the packet processing unit to the first transmitter and the second transmitter; and
the first transmitter processes the outgoing packet data into an optical signal and sends the processed optical signal in the second direction, and the second transmitter processes the outgoing packet data into an optical signal and sends the processed optical signal in the first direction.

3. The communication apparatus of claim 2, wherein the beam monitoring controller is configured to:
monitor the optical signal inputted to the first receiver and output a control signal to the selector so that the selector switches a reception path from the first path to the second path if, as a result of the monitoring, a value of the monitored optical signal is a predetermined reference value or lower; and
monitor the optical signal inputted to the second receiver and output a control signal to the selector so that the selector switches a reception path from the second path to the first path if, as a result of the monitoring, a value of the monitored optical signal is a predetermined reference value or lower.

4. The communication apparatus of claim 2, wherein each of the first receiver and the second receiver comprises:
a reception module configured to receive the optical signals;
a filter module configured to drop only the optical signal corresponding to the unique wavelength from among the received optical signals, and bypass optical signals corresponding to remaining wavelengths;
a splitter configured to split the optical signals bypassed by the filter module and transfer the split optical signals to the first transmitter and the second transmitter; and
a signal conversion module configured to convert the optical signal dropped by the filter module into the electrical signal and output the electrical signal to the selector.

5. The communication apparatus of claim 4, wherein each of the first transmitter and the second transmitter comprises:
a signal conversion module configured to convert the electrical signal received from the selector into the optical signal of the unique wavelength;
a wavelength addition module configured to add the optical signal of the unique wavelength received from the signal conversion module and the optical signal received from the splitter and output the added signal; and
a transmission module configured to send the optical signal received from the wavelength addition module in a beam form.

6. The communication apparatus of claim 1, wherein the OFDM processing unit comprises:
a signal conversion and processing unit configured to convert the optical signal received from the wireless optical transmission/reception unit into a digital signal, output the digital signal, convert a received digital signal into an analog signal, and output the analog signal to the wireless optical transmission/reception unit;
a fast Fourier transform (FFT)/inverse fast Fourier transform (IFFT) processor configured to transform the optical signal received from the signal conversion and processing unit into a signal of a frequency domain by performing FFT on the received optical signal, output the signal of the frequency domain, transform a received signal of a frequency domain into a digital signal of a time domain by performing IFFT on the received signal, and output the digital signal of the time domain to the signal conversion and processing unit; and
a subcarrier mapping processor configured to map the signal of the frequency domain received from the FFT/IFFT processor to the packet data by subcarriers, output the packet data, map the outgoing packet data received from the packet processing unit to subcarriers, and output the subcarriers.

7. The communication apparatus of claim 6, wherein the packet processing unit comprises:
a controller configured to collect pieces of information about resources, a path, and traffic received from the subcarrier mapping processor through a predetermined subcarrier, send the pieces of information to the COT, and perform path control based on path control information received from the COT through the predetermined subcarrier;
a subscriber matching unit configured to send received incoming packet data to a corresponding subscriber terminal and output outgoing packet data; and
a packet transfer layer processor configured to transfer packet data received from the subcarrier mapping processor to the subscriber matching unit as the incoming packet data, and transfer the outgoing packet data received from the subscriber matching unit to the subcarrier mapping processor in response to the path control of the controller.

8. A communication apparatus for transmitting and receiving signals to and from a plurality of remote terminal in a wireless optical communication system performing communication based on a free space,
wherein the plurality of remote terminals are arranged in a ring form around the communication apparatus, and
the communication apparatus comprises:
a wireless optical transmission/reception unit configured to split optical signals received in a first direction or a second direction opposite to the first direction by wavelengths, output the split optical signals, and transmit the optical signals having the plurality of wavelengths in the first direction and the second direction;
an orthogonal frequency division multiplexing (OFDM) processing unit configured to convert electrical signals corresponding to the optical signals received from the wireless optical transmission/reception unit into signals of a frequency domain each having a plurality of subcarriers by the wavelengths and output packet data mapped to each of the subcarriers; and
a packet optical integration and transfer unit configured to collect pieces of information about resources, a path, and traffic for the plurality of remote terminals based on the packet data received from the OFDM processing unit by the wavelengths, analyze the pieces of information about resources, a path, and traffic, generate path control information based on a result of the analysis, and provide the generated path control information to the OFDM processing unit so that the generated path control information is transferred to the plurality of remote terminals.

9. The communication apparatus of claim 8, wherein the wireless optical transmission/reception unit comprises:
a first receiver configured to receive an optical signal in the first direction;
a first transmitter configured to send an optical signal in the second direction;
a second receiver configured to receive an optical signal in the second direction;
a second transmitter configured to send an optical signal in the first direction;
a beam monitoring controller configured to monitor the optical signals inputted to the first receiver and the second receiver; and
a selector configured to transfer the optical signal received from the first receiver to the OFDM processing unit through a first path or transfer the optical signal received from the second receiver to the OFDM processing unit through a second path based on a result of the monitoring of the beam monitoring controller.

10. The communication apparatus of claim 9, wherein:
the packet optical integration and transfer unit provides the packet data for each remote terminal to the wireless optical transmission/reception unit through the OFDM processing unit;
the selector of the wireless optical transmission/reception unit transfers the received packet data for each remote terminal to the first transmitter and the second transmitter; and
the first transmitter processes the packet data into an optical signal and sends the processed optical signal in the second direction and the second transmitter processes the packet data into an optical signal and sends the processed optical signal in the first direction.

11. The communication apparatus of claim 9, wherein the beam monitoring controller is configured to:
monitor the optical signal inputted to the first receiver and output a control signal to the selector so that the selector switches a reception path from the first path to the second path if, as a result of the monitoring, a value of the monitored optical signal is a predetermined reference value or lower; and
monitor the optical signal inputted to the second receiver and output a control signal to the selector so that the selector switches a reception path from the second path to the first path if, as a result of the monitoring, a value of the monitored optical signal is a predetermined reference value or lower.

12. The communication apparatus of claim 9, wherein each of the first receiver and the second receiver comprises:
a reception module configured to receive optical signals;
a demultiplexing (DMUX) module configured to split the received optical signals by wavelengths and output the split optical signals; and
a signal conversion module configured to convert the optical signal for each wavelength into an electrical signal and output the electrical signal to the selector.

13. The communication apparatus of claim 12, wherein each the first transmitter and the second transmitter comprises:
a signal conversion module configured to convert a signal corresponding to packet data for each remote terminal received from the selector into an optical signal corresponding to a wavelength for each remote terminal;
a multiplexing (MUX) module configured to multiplex the optical signals received from the signal conversion module and output the multiplexed signals; and
a transmission module configured to send the optical signals received from the MUX module in a beam form.

14. The communication apparatus of claim 8, wherein the OFDM processing unit comprises:
a signal conversion and processing unit configured to convert the optical signal received from the wireless optical transmission/reception unit into a digital signal, output the digital signal, convert a received digital signal into an analog signal, and output the analog signal to the wireless optical transmission/reception unit;
a fast Fourier transform (FFT)/inverse fast Fourier transform (IFFT) processor configured to transform the optical signal received from the signal conversion and processing unit into a signal of a frequency domain by performing FFT on the received optical signal, output the signal of the frequency domain, transform a received signal of a frequency domain into a digital signal of a time domain by performing IFFT on the received signal, and output the digital signal of the time domain to the signal conversion and processing unit; and
a subcarrier mapping processor configured to map the signal of the frequency domain received from the FFT/IFFT processor to the packet data by subcarriers, output the packet data, map the outgoing packet data received from the packet processing unit to subcarriers, and output the subcarriers.

15. The communication apparatus of claim 14, wherein the optical packet integration and transfer unit comprises a network management controller configured to collect pieces of information about resources, a path, and traffic received from the subcarrier mapping processor through predetermined subcarriers by the remote terminals, generate the path control information based on the pieces of information about resources, a path, and traffic for the remote terminals, and transfer the generated path control information to each of the remote terminals through the predetermined subcarrier,
wherein the optical packet integration and transfer unit further comprises:
a packet transfer layer processor configured to forward the packet data received from the subcarrier mapping processor;
a switching fabric unit configured to perform a packet switching function;
an optical transfer layer processor configured to perform optical transport network (OTN) matching with the packet data received through the switching fabric unit; and
a packet optical transfer controller configured to control the packet transfer layer processor, the switching fabric unit, and the optical transfer layer processor based on the path control information so that the OTN matching is performed, and transfer outgoing packet data from each remote terminal to the OFDM processing unit.

16. A method of a communication apparatus transmitting and receiving optical signals in a wireless optical communication system in which communication is performed based on a free space and a plurality of the communication apparatuses is arranged in a ring form around a central office terminal (COT), the method comprising:
monitoring optical signals received in a first direction or in a second direction opposite to the first direction and selecting a first path through which the optical signals in the first direction are received, and a second path through which the optical signals in the second direction are received based on a result of the monitoring;
converting an optical signal having a predetermined unique wavelength from among the optical signals received through the selected path into an electrical signal;
sending optical signals having remaining wavelengths other than the optical signal having the unique wavelength from among the optical signals received through the selected path in the first direction and the second direction; and
transforming the optical signal of the unique wavelength converted into the electrical signal into a signal of a frequency domain having a plurality of subcarriers, and obtaining packet data mapped to the subcarriers.

17. The method of claim 16, further comprising sending pieces of information about resources, a path, and traffic transferred through a predetermined subcarrier from among the subcarriers to the COT, and setting up a path based on path control information received from the COT through the predetermined subcarrier.

18. The method of claim 16, further comprising:
mapping outgoing packet data to each of the subcarriers;
transforming the outgoing packet data mapped to the subcarriers into a signal of a time domain;
converting the signal of the time domain into the optical signal corresponding to the unique wavelength; and
sending the optical signal in the first direction and the second direction.

19. A method of a communication apparatus transmitting and receiving optical signals in a wireless optical communication system in which communication is performed based on a free space and a plurality of remote terminals are arranged in a ring form around a communication apparatus, the method comprising:
monitoring optical signals received in a first direction or in a second direction opposite to the first direction, and selecting a first path through which the optical signals in the first direction are received and a second path through which the optical signals in the second direction are received based on a result of the monitoring;
splitting the optical signals received through the selected path by wavelengths corresponding to the respective remote terminals and converting each of the optical signals for each wavelength into an electrical signal;
transforming the optical signal converted into the electrical signal into a signal of a frequency domain having a plurality of subcarriers by the wavelength and obtaining packet data mapped to each of the subcarriers; and
setting up a path for each of the plurality of remote terminals based on pieces of information about resources, a path, and traffic received through a predetermined subcarrier, from among the subcarriers for each wavelength.

20. The method of claim 19, further comprising:
mapping outgoing packet data for each remote terminal to a subcarrier;
transforming the outgoing packet data mapped to the subcarrier into a signal of a time domain;
converting the signal of the time domain into an optical signal having a wavelength corresponding to each of the remote terminals; and
sending the optical signals in the first direction and the second direction.
